(19) United States
(12) Patent Application Publication
(10) Pub. No.: US 2024/0155517 A1
(43) Pub. Date: May 9, 2024

(54) ENHANCED UPLINK POWER CONTROL

(71) Applicant: Intel Corporation, Santa Clara, CA (US)

(72) Inventors: Guotong Wang, Beijing (CN); Alexei Davydov, Nizhny Novgorod (RU)

(21) Appl. No.: 18/279,247

(22) PCT Filed: Mar. 14, 2022
(86) PCT No.: PCT/US2022/020168

§ 371 Date: Aug. 29, 2023

(30) Foreign Application Priority Data
Mar. 16, 2021 (WO) PCT/CN2021/081025
Apr. 15, 2021 (WO) PCT/CN2021/087373
Sep. 14, 2021 (WO) PCT/CN2021/118257
Oct. 19, 2021 (WO) PCT/CN2021/124550

(51) Int. Cl. H04W 52/40; H04L 5/00; H04W 52/10; H04W 52/14

(52) U.S. Cl. CPC H04W 52/40; H04L 5/0035; H04W 52/10; H04W 52/146; H04L 5/0048

(57) ABSTRACT

An apparatus and system for uplink power control in multi-transmission/reception point (TRP) operation are described. Power control of sounding reference signals (SRS) to different TRPs is indicated in downlink control information (DCI). The SRS power control adjustments states may be related to or separate from physical uplink shared channel (PUSCH) power control adjustments states to the TRPs and may be indicated intrinsically based on order or extrinsically using additional bits in the DCI. Multiple SRS resource sets are used for codebook-based transmission, which is used for the mapping between SRS resource index (SRI) and pathloss reference signal, spatial relation, P0 and alpha value.

### PRIORITY CLAIM

This application claims the benefit of priority to International Application No. PCT/CN2021/081025, filed Mar. 16, 2021, International Application No. PCT/CN2021/087373, filed Apr. 15, 2021, International Application No. PCT/CN2021/118257, filed Sep. 14, 2021, and International Application No. PCT/CN2021/124550, filed Oct. 19, 2021, each which is incorporated herein by reference in its entirety.

### TECHNICAL FIELD

Embodiments pertain to next generation (NG) wireless communications. In particular, some embodiments relate to uplink power control.

### BACKGROUND

The use and complexity of new radio (NR) wireless systems, which include 5th generation (5G) networks and are starting to include sixth generation (6G) networks among others, has increased due to both an increase in the types of devices UEs using network resources as well as the amount of data and bandwidth being used by various applications, such as video streaming, operating on these UEs. With the vast increase in number and diversity of communication devices, the corresponding network environment, including routers, switches, bridges, gateways, firewalls, and load balancers, has become increasingly complicated. As expected, a number of issues abound with the advent of any new technology.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a Sounding Reference Signal (SRS) power control state in accordance with some aspects.

FIG. 4 illustrates another SRS power control state in accordance with some aspects.

FIG. 5 illustrates transmission/reception point (TRP) transmission in accordance with some aspects.

FIG. 6 illustrates another TRP transmission in accordance with some aspects.

FIG. 7 illustrates TRP command transmission in accordance with some aspects.

FIG. 8 illustrates power control for SRS antenna switching in accordance with some aspects.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

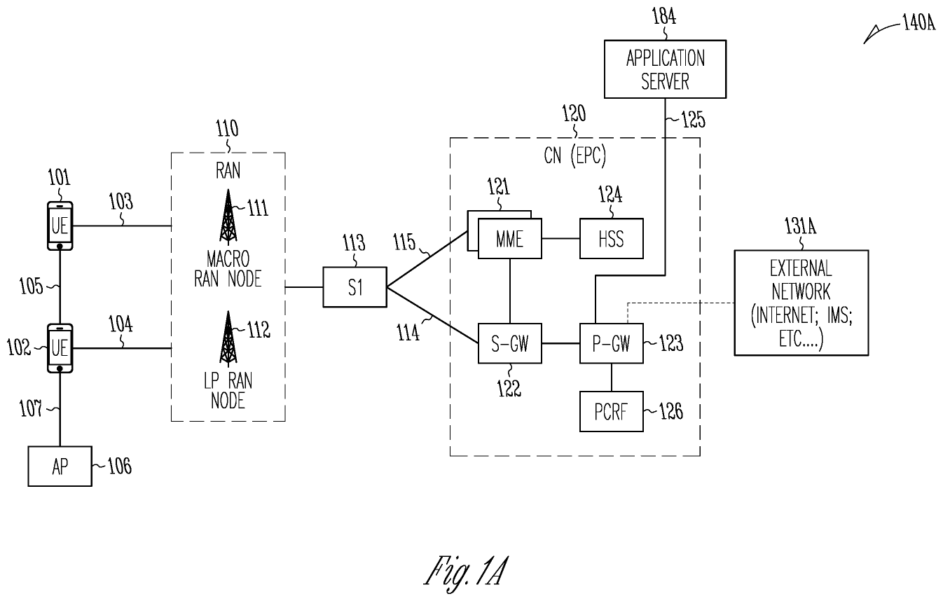

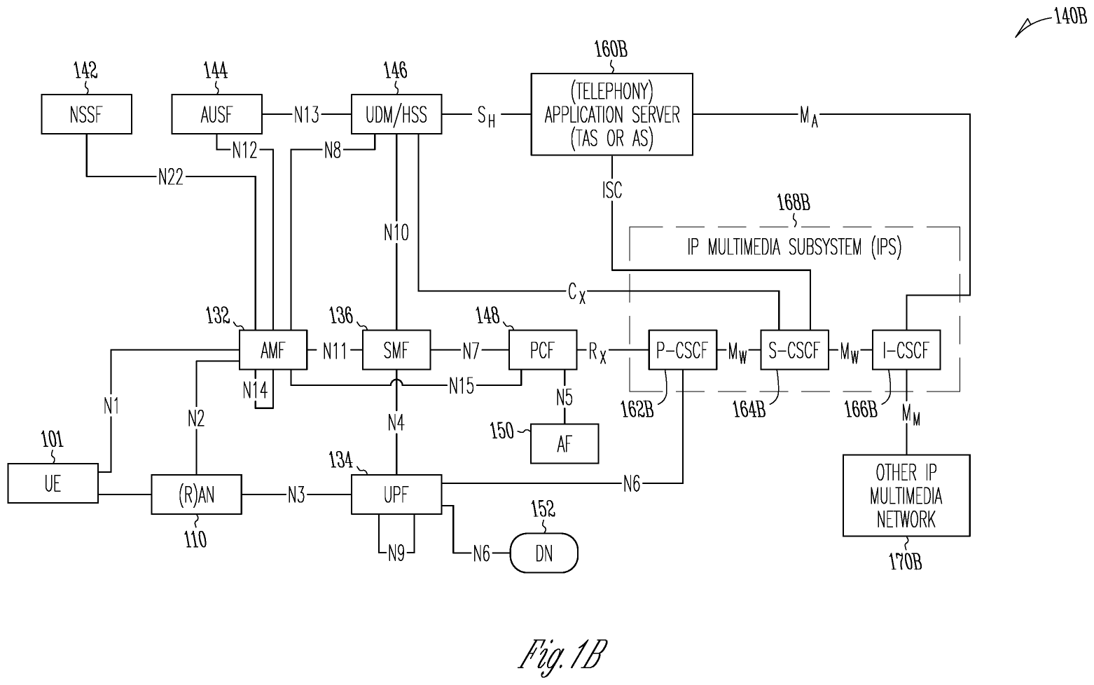

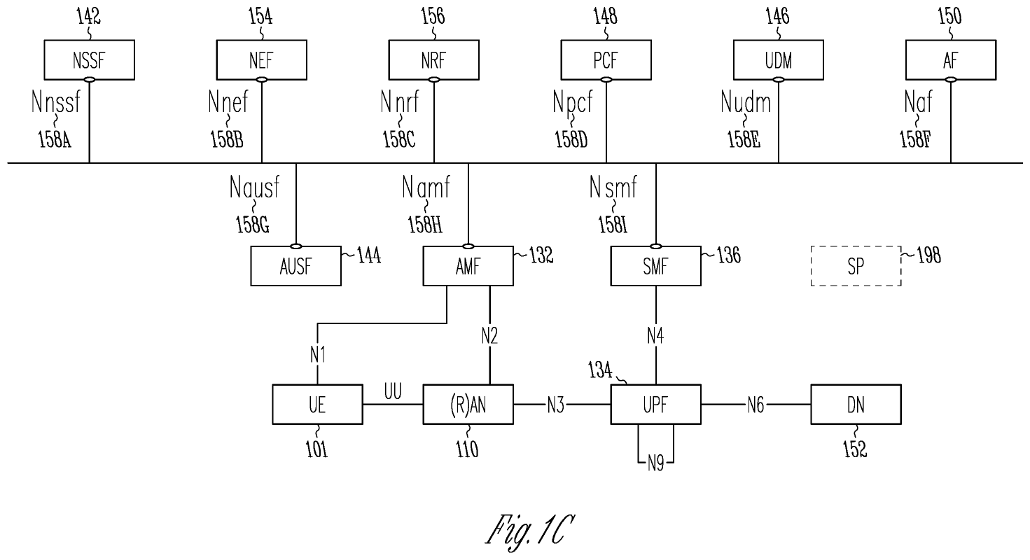

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHZ, and other frequencies and Spectrum Access System (SAS) in 3.55-3.7 GHZ and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation (5^{th} or 6^{th} generation) NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs).

In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

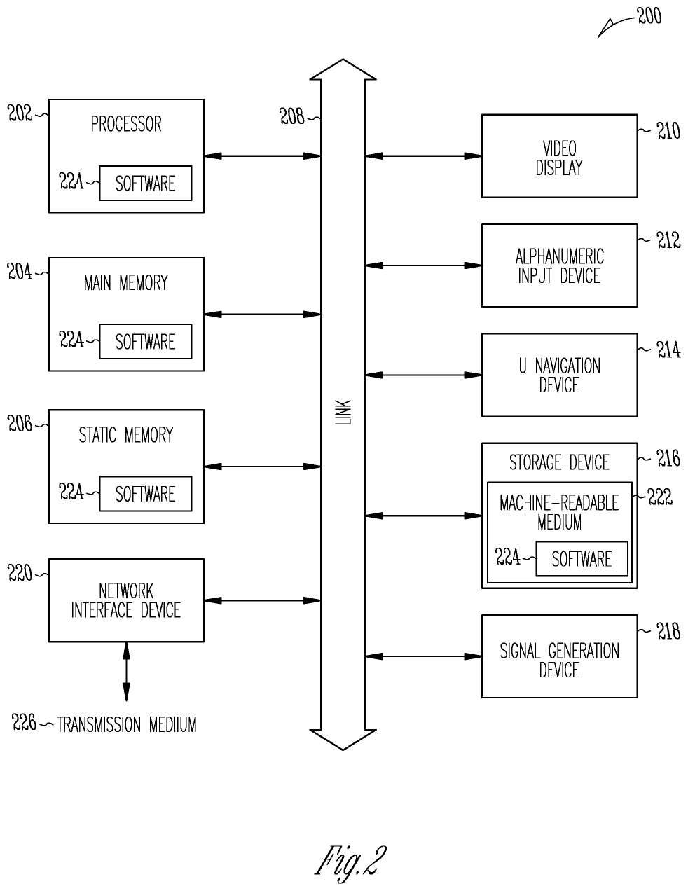

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10) , 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHZ), ITS-G5B (i.e., Operation in European ITS frequency bands dedicated to ITS non- safety applications in the frequency range 5,855 GHz to 5,875 GHZ), ITS-G5C (i.e., Operation of ITS applications in the frequency range 5,470 GHz to 5,725 GHZ)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHZ, 1710-2025 MHz, 2110-2200 MHz, 2300-2400 MHZ, 2.4-2.4835 GHz (note: it is an ISM band with global availability and it is used by Wi-Fi technology family (11b/g/n/ax) and also by Bluetooth), 2500-2690 MHz, 698-790 MHZ, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHZ (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHz, 31-31.3 GHZ, 37-38.6 GHZ, 38.6-40 GHz, 42-42.5 GHZ, 57-64 GHz, 71-76 GHz, 81-86 GHz and 92-94 GHz, etc), the ITS (Intelligent Transport Systems) band of 5.9 GHZ (typically 5.85-5.925 GHZ) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHZ) and WiGig Band 4 (63.72-65.88 GHz), 57-64/66 GHz (note: this band has near-global designation for Multi-Gigabit Wireless Systems (MGWS)/WiGig . In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

Some of the features are defined for the network side, such as APs, eNBs, NR or gNBs—note that this term is typically used in the context of 3GPP 5G and 6G communication systems, etc. Still, a UE may take this role as well and act as an AP, eNB, or gNB; that is some or all features defined for network equipment may be implemented by a UE.

As above, in the NR Rel-15 specification, different types of SRS resource sets are supported. The SRS resource set is configured with a parameter of ‘usage’, which can be set to ‘beamManagement’, ‘codebook’, ‘nonCodebook’ or ‘antennaSwitching’. The SRS resource set configured for ‘beamManagement’ is used for beam acquisition and uplink beam indication using SRS. The SRS resource set configured for ‘codebook’ and ‘nonCodebook’ is used to determine the UL precoding with explicit indication by transmission precoding matrix index (TPMI) or implicit indication by SRS resource index (SRI). Finally, the SRS resource set configured for ‘antennaSwitching’ is used to acquire DL channel state information (CSI) using SRS measurements in the UE by leveraging reciprocity of the channel in time domain duplexing (TDD) systems. For SRS transmission, the time domain behavior may be periodic, semi-persistent or aperiodic. The RRC configuration for SRS resource set is:

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS- |
| ResourcesPerSet)) OF SRS-ResourceId | OPTIONAL, -- Cond Setup |
| resourceType | CHOICE { |
| aperiodic | SEQUENCE { |
| aperiodicSRS-ResourceTrigger | INTEGER (1..maxNrofSRS- |
| TriggerStates-1), | |
| csi-RS | NZP-CSI-RS-ResourceId |
| OPTIONAL, -- Cond NonCodebook | |
| slotOffset | INTEGER (1..32) |
| OPTIONAL, -- Need S | |
| ..., | |
| [[ | |
| aperiodicSRS-ResourceTriggerList | SEQUENCE |
| (SIZE(1..maxNrofSRS-TriggerStates-2)) | |
| | OF INTEGER (1..maxNrofSRS- |

TriggerStates-1) OPTIONAL -- Need M

| | |
|---|---|
| ]] | |
| }, | |
| semi-persistent | SEQUENCE { |
| associatedCSI-RS | NZP-CSI-RS-ResourceId |
| OPTIONAL, -- Cond NonCodebook | |
| ... | |
| }, | |
| periodic | SEQUENCE { |
| associatedCSI-RS | NZP-CSI-RS-ResourceId |
| OPTIONAL, -- Cond NonCodebook | |
| ... | |
| } | |
| }, | |
| usage | ENUMERATED {beamManagement, codebook, |
| nonCodebook, antennaSwitching}, | |
| alpha | Alpha |
| OPTIONAL, -- Need S | |
| p0 | INTEGER (−202..24) |
| OPTIONAL, -- Cond Setup | |
| pathlossReferenceRS | PathlossReferenceRS-Config |
| OPTIONAL, -- Need M | |
| srs-PowerControlAdjustmentStates | ENUMERATED { sameAsFci2, |
| separateClosedLoop} | OPTIONAL, -- Need S |

When the SRS resource set is configured as ‘aperiodic’, the SRS resource set also includes configuration of trigger state(s) (aperiodicSRS-Resource Trigger, aperiodicSRS-Resource TriggerList). The triggering state(s) defines which downlink control information (DCI) codepoint(s) triggers the corresponding SRS resource set transmission.

The aperiodic SRS may be triggered via an SRS Request field in the DCI. The SRS Request field may be carried by DCI format 0_1/0_2/1_1/1_2/2_3. Note that DCI format 0_1/0_2 is used for scheduling the physical uplink shared channel (PUSCH), DCI format 1_1/1_2 is used for scheduling the physical downlink shared channel (PDSCH) and DCI format 2_3 is used to trigger aperiodic SRS for a group of UEs.

In the RRC configuration, parameter srs-PowerControlAdjustmentStates defines whether the SRS power control state should follow the PUSCH or is separate from the PUSCH. If the parameter srs-PowerControlAdjustmentStates is not present, then SRS power control should follow the 1^{st} PUSCH power control adjustment state, i.e., h_{b,f,c}=f_{b,f,c}(i, 0). If the parameter srs-PowerControlAdjustmentStates is present and the value is same AsFci2, then SRS power control should follow the 2^{nd} PUSCH power control adjustment state, i.e., h_{b,f,c}=f_{b,f,c}(i, 1). If the parameter srs-PowerControlAdjustmentStates is present and the value is separateClosedLoop, then SRS power control is configured with a separate power control state.

The output power of the PUSCH is shown as below equation:

$${P}_{PUSCH , b , f , c} ( i , j , {q}_{d} , l ) = min \{ \begin{matrix}{P}_{CMAX , f , c} ( i ) \\ {P}_{0 \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ] \qquad ( 1 )$$

The parameters are: b: UL BWP index; f: Carrier index; c: Serving cell; j: Parameter set configuration index; l: PUSCH power control adjustment state index; i: PUSCH transmission occasion; q_{d}: Reference signal index used for pathloss calculation, corresponding to different beam. Generally, each component in the formula is: P_{CMAX}: The UE maximum output power; P_{0_PUSCH}: The target received PUSCH power; M: Bandwidth in number of resource blocks; α: Pathloss compensation factor; PL: Pathloss (beam specific); Δ: Adjustment according to MCS; f_{b,f,c}(i, l): Adjustment according to a transmit power control (TPC) command from gNB, wherein l∈{0,1}.

Similarly, the output power of SRS is derived by:

$${P}_{SRS , b , f , c} ( i , {q}_{s} , l ) = min \{ \begin{matrix}{P}_{CMAX , f , c} ( i ) \\ {P}_{0 \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix} \} [ dBm ] \qquad ( 2 )$$

The parameters are as below:

The parameters are: b: UL BWP index; f: Carrier index; c: Serving cell; q_{S}: SRS resource set ID; l: SRS power control adjustment state index; i: SRS transmission occasion; q_{d}: Reference signal index used for pathloss calculation, corresponding to different beam. Each component in the formula for SRS power control is: P_{CMAX}: The UE maximum output power; P_{0_SRS}: The target received SRS power; M: Bandwidth in number of resource blocks; α: Pathloss compensation factor; PL: Pathloss (beam specific); h_{b,f,c}(i, l): Adjustment according to TPC command from gNB. The power control adjustment state for SRS may be the same or different with than that of the PUSCH.

However, several issues arise with this. In Release 17, it has been agreed that SRS may be triggered by DCI format 0_1/0_2 without a scheduling PUSCH. In this case, a separate power control state may applied for the SRS since the PUSCH is not transmitted. However, in multi-TRP operation, the UE may be configured with two SRS resource sets for codebook/non-codebook based transmission. If multiple SRS resource sets toward different TRPs are triggered via the same DCI, then the same separate power control state is applied, which is not desirable since the SRS transmission is toward different TRP.

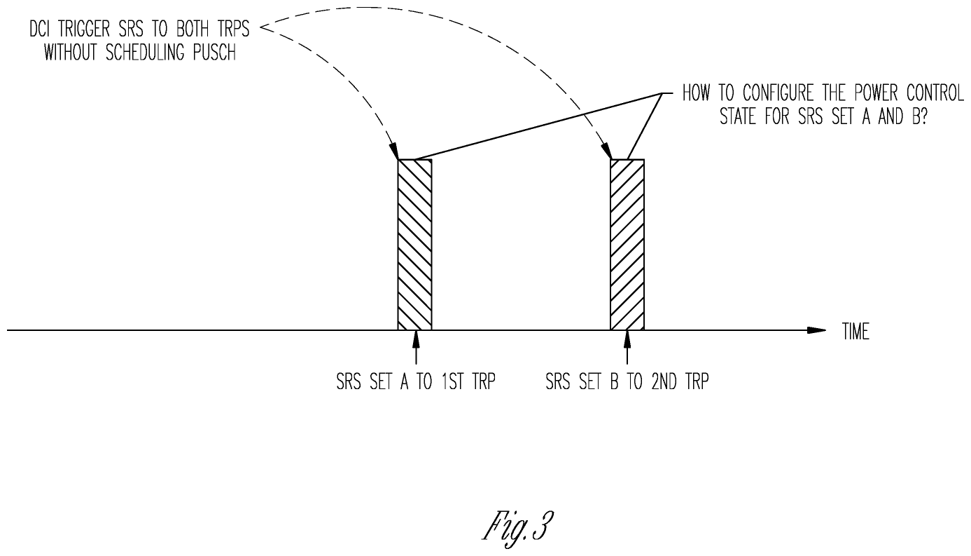

FIG. 3 illustrates an SRS power control state in accordance with some aspects. In particular, in FIG. 3, the SRS power control state is for a DCI 0_1/0_2 without a scheduling PUSCH and shows the issue with configuration of multiple TRPs. In addition, there should be two TPC commands for an SRS triggered by DCI format 0_1/0_2 without a scheduling PUSCH; dynamic switching between a single TRP and multiple TRPs should also be supported.

The same issue can be observed for an SRS triggered by DCI format 2_3 in the scenario of multi-TRP operation. Another issue, for multi-TRP operation, involves support for

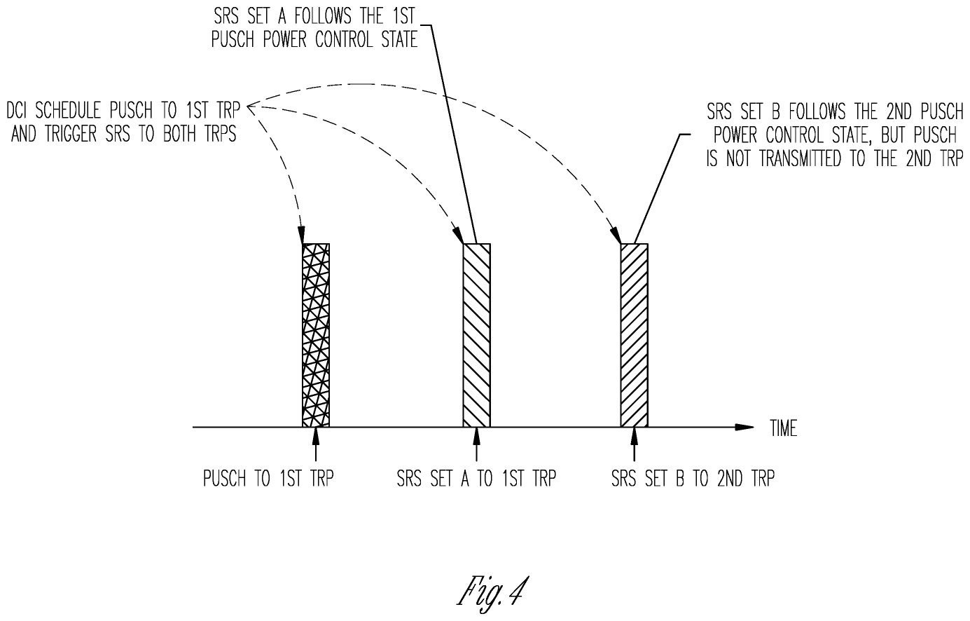

dynamic switching between a single TRP and multi-TRP. For an SRS triggered by DCI format 0_1/0_2 scheduling a PUSCH, the power control state for the SRS may be problematic if the DCI schedules the PUSCH transmission only toward one TRP, but the SRS Request triggers SRS transmission toward two TRPs. FIG. 4 illustrates another SRS power control state in accordance with some aspects.

For example, take the case of a UE configured with SRS resource set A and B. SRS resource set A is configured with the same power control state as the 1^{st} PUSCH power control state, i.e., f_{b,f,c}(i, 0), and SRS resource set B is configured with the same power control state as the 2^{nd} PUSCH power control state, i.e., f_{b,f,c}(i, 1). If the DCI scheduling the PUSCH transmission to the 1^{st} TRP (TRP #1, corresponding to the 1^{st} PUSCH power control state) also triggers both SRS resource set A and B, then whether SRS resource set B is to follow the 2^{nd} PUSCH power control state is problematic because the PUSCH is not transmitted to the 2^{nd} TRP. FIG. 4 shows the SRS power control state for DCI 0_1/0_2 scheduling the PUSCH.

In addition, the UE may be configured with two power control states (l∈{0,1}) for PUSCH transmission in multi-TRP operation. Which power control state is applied may be determined by a mapping between the SRI and power control state l. In this case, the mapping is provided by the RRC parameter sri-PUSCH-ClosedLoopIndex in SRI-PUSCH-PowerControl:

| | |
|---|---|
| SRI-PUSCH-PowerControl ::= | SEQUENCE { |
| sri-PUSCH-PowerControlId | SRI-PUSCH-PowerControlId, |
| sri-PUSCH-PathlossReferenceRS-Id | PUSCH-PathlossReferenceRS-Id, |
| sri-P0-PUSCH-AlphaSetId | P0-PUSCH-AlphaSetId, |
| sri-PUSCH-ClosedLoopIndex | ENUMERATED { i0, i1 } |
| } | |

However, in Rel-17, it has been agreed that for codebook/non-codebook based transmission in multi-TRP operation, the maximum number of SRS resource sets is two. This means that the transmission to different TRPs will be differentiated by different SRS resource sets. For example, the 1^{st} SRS resource set corresponds to the 1^{st} TRP and the 2^{nd} SRS resource set corresponds to the 2^{nd} TRP. In this case, the PUSCH power control state should be derived from different SRS resource set than the SRI. Accordingly, a method is presented herein on SRS and PUSCH power control enhancement to support multi-TRP operation.

Scenario A: SRS Triggered by DCI Format 0_1/0_2 Without Scheduling a PUSCH

In some embodiments, for single TRP operation, when an SRS is triggered by DCI format 0_1/0_2 without a scheduling PUSCH, the TPC command carried in the DCI is applied for SRS power control. An example of the specification change is shown as below. For SRS power control in Section 7.3.1 of TS 38.213 v16.4.0:

For the SRS power control adjustment state for active UL BWP b of carrier f of serving cell c and SRS transmission occasion i: h_{b,f,c}(i,l)=f_{b,f,c}(i,l), where f_{b,f,c}(i,l) is the current PUSCH power control adjustment state as described in Clause 7.1.1, if srs-PowerControlAdjustmentStates indicates a same power control adjustment state for SRS transmissions and PUSCH transmissions and SRS is triggered by DCI format 0_1/0_2 scheduling a PUSCH; or h_{b,f,c}(i)=h_{b,f,c}(i−i₀)+Σₘ₌₀^{C(S}^{ᵢ}⁾⁻¹ δ_{SRS,b,f,c}(m) is srs-PowerControlAdjustmentStates indicates a same power control adjustment state for SRS transmissions and PUSCH transmissions and the SRS is triggered by DCI format 0_1/0_2 without scheduling a PUSCH, and if tpc-Accumulation is not provided, where:

The δ_{SRS,b,f,c} values are given in Table 7.1.1-1

δ_{SRS,b,f,c}(m) is TPC command included in DCI format 0_1/0_2 without scheduling PUSCH.

h_{b,f,c}(i)=&SRS.b.f.c(i) if srs-PowerControl AdjustmentStates

indicates a same power control adjustment state for SRS transmissions and PUSCH transmissions and SRS is triggered by DCI format 0_1/0_2 without scheduling PUSCH, and if tpc-Accumulation is provided

h_{b,f,c}(i)=h_{b,f,c}(i−i₀)+Σₘ₌₀^{C(S}^{ᵢ}⁾⁻¹ δ_{SRS,b,f,c}(m) if the UE is not configured for PUSCH transmissions on active UL BWP b of carrier f of serving cell C, or if srs-PowerControlAdjustmentStates indicates separate power control adjustment states between SRS transmissions and PUSCH transmissions, and if tpc-Accumulation is not provided, where

The δ_{SRS,b,f,c} values are given in Table 7.1.1-1

δ_{SRS,b,f,c} (m)is jointly coded with other TPC commands in a PDCCH with DCI format 2_3, as described in Clause 11.4.

In some embodiments, in multi-TRP operation, the SRS power control states are extended to include two separate power control adjustment states from the PUSCH. The two separate power control states may be applied for SRS power control if the SRS is triggered by DCI format 0_1/0_2 without scheduling a PUSCH. The SRS power control state may be one of the following: the same as the 1^{st} PUSCH power control adjustment state; the same as the 2^{nd} PUSCH power control adjustment state; the 1^{st} separate power control state from the PUSCH; or the 2^{nd} separate power control state from the PUSCH.

For example, the value of srs-PowerControlAdjustmentStates may be: {sameAsFci2, separateClosedLoop-1, separateClosedLoop-2}. If the parameter srs-PowerControlAdjustmentStates is not present, then the SRS power control should follow the 1^{st} PUSCH power control adjustment state, i.e., h_{b,f,c}=f_{b,f,c}(i, 0). If the parameter srs-PowerControlAdjustmentStates is present and the value is sameAsFci2, then the SRS power control should follow the 2^{nd} PUSCH power control adjustment state, i.e., h_{b,f,c}=f_{b,f,c}(i, 1). If the parameter srs-PowerControlAdjustmentStates is present and the value is separate ClosedLoop-1, then the SRS is configured with the 1^{st} separate power control state. If the parameter srs-PowerControlAdjustmentStates is present and the value is separateClosedLoop-2, then the SRS is configured with the 2nd separate power control state.

An example of the specification change for SRS power control in Section 7.3.1 of TS38.213 v16.4.0:

For the SRS power control adjustment state for active UL BWP b of carrier f of serving cell c and SRS transmission occasion i:

h_{b,f,c}(i,l)=f_{b,f,c}(i,l), where f_{b,f,c}(i,l) is the current PUSCH power control adjustment state as described in Clause 7.1.1, if srs-PowerControlAdjustmentStates indicates a same power control adjustment state for SRS transmissions and PUSCH transmissions; or

h_{b,f,c}(i, l)=h_{b,f,c}(i−i₀, l)+Σₘ₌₀^{C(S}^{ᵢ}⁾⁻¹δ_{SRS,b,f,c}(m, l) if the UE is not configured for PUSCH transmissions on the active UL BWP b of carrier f of serving cell c, or if srs-PowerControlAdjustmentStates indicates separate power control adjustment states between SRS transmissions and PUSCH transmissions, and if tpc-Accumulation is not provided, where:

The δ_{SRS,b,f,c} values are given in Table 7.1.1-1

δ_{SRS,b,f,c}(m, l)is jointly coded with other TPC commands in a PDCCH with DCI format 2_3, as described in Clause 11.4 or is a TPC command value included in a DCI format 0_1/0_2 without scheduling a PUSCH.

h_{b,f,c}(i, l)=δ_{SRS,b,f,c}(i, l) if the UE is not configured for PUSCH transmissions on active UL BWP b of carrier f of serving cell c, or if srs-PowerControlAdjustmentStates indicates separate power control adjustment states between SRS transmissions and PUSCH transmissions, and tpc-Accumulation is provided, and the UE detects a DCI format 2_3, or a DCI format 0_1/0_2 without scheduling a PUSCH, K_{SRS,min} symbols before a first symbol of SRS transmission occasion i, where absolute values of δ_{SRS,b,f,c} are provided in Table 7.1.1-1.

In another embodiment, the SRS still use the existing three power control adjustment states, i.e., same as the 1^{st} PUSCH power control state, same as the 2^{nd} PUSCH power control state, and a separate power control state from the PUSCH. If the SRS is triggered by DCI 0_1/0_2 without scheduling a PUSCH, then the DCI should be considered for SRS power control adjustment h_{b,f,c}(i, l). If SRS is configured to be the same as the 1^{st} PUSCH power control state, then l=0. If SRS is configured to be the same as the 2^{nd} PUSCH power control state, then l=1.

An example of the spec change is shown as below. For SRS power control in Section 7.3.1 of TS38.213 v16.4.0:

For the SRS power control adjustment state for active UL BWP b of carrier f of serving cell c and SRS transmission occasion i:

h_{b,f,c}(i, l)=f_{b,f,c}(i,l), where f_{b,f,c}(i,l) is the current PUSCH power control adjustment state as described in Clause 7.1.1, if srs-PowerControlAdjustmentStates indicates a same power control adjustment state for SRS transmissions and PUSCH transmissions and the SRS is triggered by DCI format 0_1/0_2 scheduling PUSCH; or

h_{b,f,c}(i, l)=h_{b,f,c}(i−i₀, l)+Σₘ₌₀^{C(S}^{ᵢ}⁾⁻¹δ_{SRS,b,f,c}(m, l) if srs-PowerControlAdjustmentStates indicates a same power control adjustment state for SRS transmissions and PUSCH transmissions and the SRS is triggered by DCI format 0_1/0_2 without scheduling a PUSCH, and if tpc-Accumulation is not provided, where: the δ_{SRS,b,f,c} values are given in Table 7.1.1-1; δ_{SRS,b,f,c}(m) is a TPC command included in DCI format 0_1/0_2 without scheduling a PUSCH; and l=0 if srs-PowerControlAdjustmentStates indicates the same as the 1^{st} PUSCH power control state while l=1 if srs-PowerControlAdjustmentStates indicates the same as the 2^{nd} PUSCH power control state.

h_{b,f,c}(i, l)=δ_{SRS,b,f,c}(i, l) if srs-PowerControl AdjustmentStates indicates a same power control adjustment state for SRS transmissions and PUSCH transmissions and the SRS is triggered by DCI format 0_1/0_2 without scheduling a PUSCH, and if tpc-Accumulation is provided, where l=0 if srs-PowerControlAdjustmentStates indicates the same as the 1^{st} PUSCH power control state while l=1 if srs-PowerControlAdjustmentStates indicates the same as the 2^{nd} PUSCH power control state.

h_{b,f,c}(i, l)=h_{b,f,c}(i−i₀, l)+Σₘ₌₀^{C(S}^{ᵢ}⁾⁻¹δ_{SRS,b,f,c}(m) if the UE is not configured for PUSCH transmissions on the active UL BWP b of carrier f of serving cell c and SRS transmission occasion i or if srs-PowerControlAdjustmentStates indicates separate power control adjustment states between SRS transmissions and PUSCH transmissions, and if tpc-Accumulation is not provided, where the δ_{SRS,b,f,c} values are given in Table 7.1.1-1, and δ_{SRS,b,f,c}(m) is jointly coded with other TPC commands in a PDCCH with DCI format 2_3, as described in Clause 11.4.

In another embodiment, for SRS triggered by DCI 0_1/0_2 without scheduling a PUSCH, two TPC commands are included in the DCI 0_1/0_2 in multi-TRP operation. Each TPC command applies to the SRS transmission toward the respective TRP. Two TPC command fields may be included in the DCI, and each TPC command field contains one TPC command. Or only one TPC command field is included in the DCI, and the codepoint of the DCI field may indicate two TPC commands.

The application of TPC command to the SRS power control state may be implicitly or explicitly indicated. With implicit indication, for example, the first TPC command applies to the SRS transmission to the 1^{st} TRP, i.e., the SRS with the 1^{st} power control state. The second TPC command applies to the SRS transmission to the 2^{nd} TRP, i.e., the SRS with the 2^{nd} power control state. A triggered SRS selects the corresponding TPC command according to the power control state configuration.

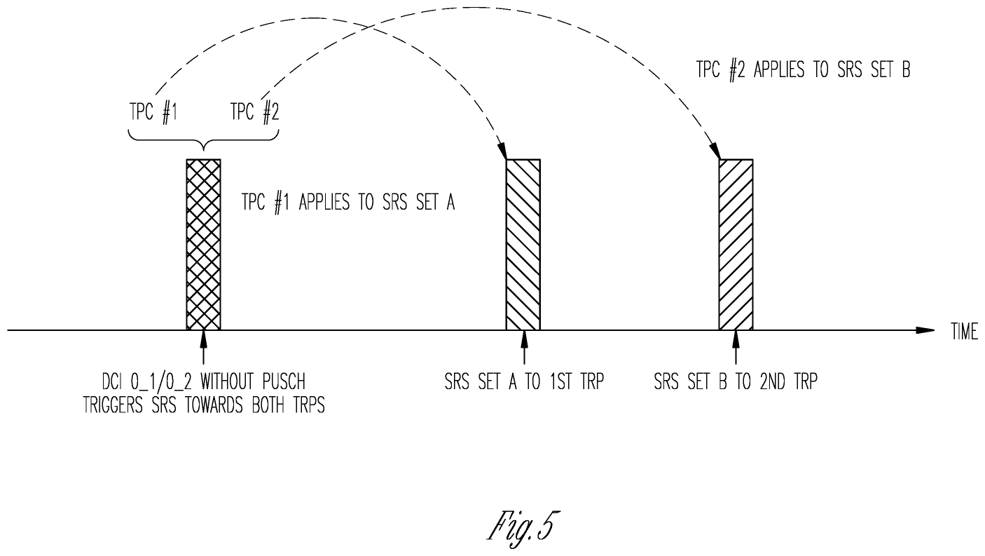

FIG. 5 illustrates TRP transmission in accordance with some aspects. In particular, FIG. 5 shows an example application of TPC over DCI 0_1/0_2 without a PUSCH to indicate SRS. With explicit indication, additional bit(s) are added to indicate whether the TPC command is applied to the 1^{st} SRS power control state or the 2^{nd} SRS power control state.

Dynamic switching between multi-TRP and single TRP operation is also supported. In an example, the two TPC commands are always included in the DCI. Whether a single TPC command or both TPC commands will be applied is further determined by the power control state configuration of the triggered SRS. In another example, in the DCI 0_1/0_2 without scheduling a PUSCH, whether a single TPC command is included or two TPC commands are included is configurable.

This embodiment may be applicable to both single DCI multi-TRP and multi-DCI multi-TRP operation. In another example, this embodiment may only be applicable for single DCI multi-TRP operation. For multi-DCI multi-TRP operation, only one TPC command is included in the DCI.

In another embodiment, for an SRS triggered by DCI format 0_1/0_2 without scheduling a PUSCH, unused fields may be reused to reconfigure parameters for the SRS. One, several, or all of the following SRS power control parameters may be reconfigured via the unused bits in DCI format 0_1/0_2 without scheduling a PUSCH:

SRS power control adjustment state—one of the applicable SRS power control adjustment states may be dynamically indicated over the DCI. For example, the RRC-configured power control state for the SRS is the same as the 1^{st} PUSCH power control state. In the DCI, the state may be reconfigured as a different state, for example, the separate power control state as the PUSCH or the 1^{st} separate power control state (if there are two separate power control states).

Pathloss reference signal—a list of pathloss reference signal may be configured by RRC. In the DCI, the applicable pathloss reference signal may be indicated for the SRS.

Spatial relation—a list of spatial relations may be configured by RRC. In the DCI, the applicable spatial relation may be indicated for the SRS.

P0 and alpha value—a list of P0 and a list of alpha, or a list of PO and alpha may be configured by RRC. In the DCI, the applicable P0 and alpha may be indicated for the SRS.

Note: this embodiment may be applied for both single TRP operation and multi-TRP operation.

In another embodiment, for an SRS triggered by DCI format 0_1/0_2 without scheduling a PUSCH, no matter whether in multi-TRP operation or single TRP operation, only open loop power control is applied for the triggered SRS, i.e., h_{b,f,c}(i, l)=0.

In another example, for an SRS triggered by DCI format 0_1/0 2 without scheduling a PUSCH, the triggered SRS may be configured with alpha and/or P0 values, which implicitly means open loop power control is performed for the triggered SRS.

In another embodiment, for an SRS triggered by DCI format 0_1/0_2 without scheduling a PUSCH, only an SRS with the same power control state as the PUSCH can be triggered. In another alternative, the SRS with same or separate power control state as the PUSCH can be triggered by DCI format 0_1/0_2 without scheduling a PUSCH.

### Scenario B: SRS Triggered by DCI Format 2_3

In an embodiment, in multi-TRP operation, for an SRS triggered by DCI format 2_3, the SRS power control states may be extended to include two separate power control adjustment states from the PUSCH. The two separate power control adjustment states may be applied for SRS power control if the SRS is triggered by DCI format 2_3. The SRS power control state may be one of the following: the same as the 1^{st} PUSCH power control adjustment state; the same as the 2^{nd} PUSCH power control adjustment state; a 1^{st} separate power control state from that of the PUSCH; or a 2^{nd} separate power control state from that of the PUSCH.

For example, the value of srs-PowerControlAdjustmentStates may be: {sameAsFci2, separateClosedLoop-1, separateClosedLoop-2}. In this case: if the parameter srs-PowerControlAdjustmentStates is not present, then the SRS power control should follow the 1^{st} PUSCH power control adjustment state, i.e. h_{b,f,c}=f_{b,f,c}(i, 0); if the parameter srs-PowerControlAdjustmentStates is present and the value is sameAsFci2, then the SRS power control should follow the 2^{nd} PUSCH power control adjustment state, i.e. h_{b,f,c}=f_{b,f,c}(i, 1); if the parameter srs-PowerControlAdjustmentStates is present and the value is separate ClosedLoop-1, then the SRS is configured with the 1^{st} separate power control state; and if the parameter srs-PowerControlAdjustmentStates is present and the value is separateClosedLoop-2, then the SRS is configured with the 2^{nd} separate power control state.

An example of the spec change is shown as below. For SRS power control in Section 7.3.1 of TS38.213 v16.4.0:

For the SRS power control adjustment state for active UL BWP b of carrier f of serving cell c and SRS transmission occasion i:

h_{b,f,c}(i,l) 32 f_{b,f,c}(i,l), where f_{b,f,c}(i,l) is the current PUSCH power control adjustment state as described in Clause 7.1.1, if srs-PowerControlAdjustmentStates indicates a same power control adjustment state for SRS transmissions and PUSCH transmissions; or

h_{b,f,c}(i, l)=h_{b,f,c}(i−i₀, l)+Σₘ₌₀^{C(S}^{ᵢ}⁾⁻¹δ_{SRS,b,f,c}(m, l) if the UE is not configured for PUSCH transmissions on the active UL BWP b of carrier f of serving cell c, or if srs-PowerControlAdjustmentStates indicates separate power control adjustment states between SRS transmissions and PUSCH transmissions, and if tpc-Accumulation is not provided, where:

The δ_{SRS,b,f,c} values are given in Table 7.1.1-1

δ_{SRS,b,f,c}(m, l)is jointly coded with other TPC commands in a PDCCH with DCI format 2_3, as described in Clause 11.4.

l=0 if srs-PowerControl AdjustmentStates indicates the 1^{st} separate power control state and l=1 if srs-PowerControlAdjustmentStates indicates the 2^{nd} separate power control state.

h_{b,f,c}(i, l)=δ_{SRS,b,f,c}(i, l) if the UE is not configured for PUSCH transmissions on the active UL BWP b of carrier f of serving cell c, or if srs-PowerControlAdjustmentStates indicates separate power control adjustment states between SRS transmissions and PUSCH transmissions, and tpc-Accumulation is provided, and the UE detects a DCI format 2_3, or a DCI format 0_1/0_2 without scheduling a PUSCH, K_{SRS,min} symbols before a first symbol of SRS transmission occasion i, where absolute values of δ_{SRS,b,f,c} are provided in Table 7.1.1-1.

l=0 if srs-PowerControlAdjustmentStates indicates the 1^{st} separate power control state and l=1 if srs-PowerControlAdjustmentStates indicates the 2^{nd} separate power control state.

In another embodiment, for an SRS triggered by DCI 2_3, there may be two TPC commands included in the DCI 2_3 in multi-TRP operation. Each TPC command applies to the SRS transmission toward the respective TRP. Two TPC command fields may be included in the DCI, and each TPC command field contains one TPC command. Or only one TPC command field is included in the DCI, and the codepoint of the DCI field may indicate two TPC commands.

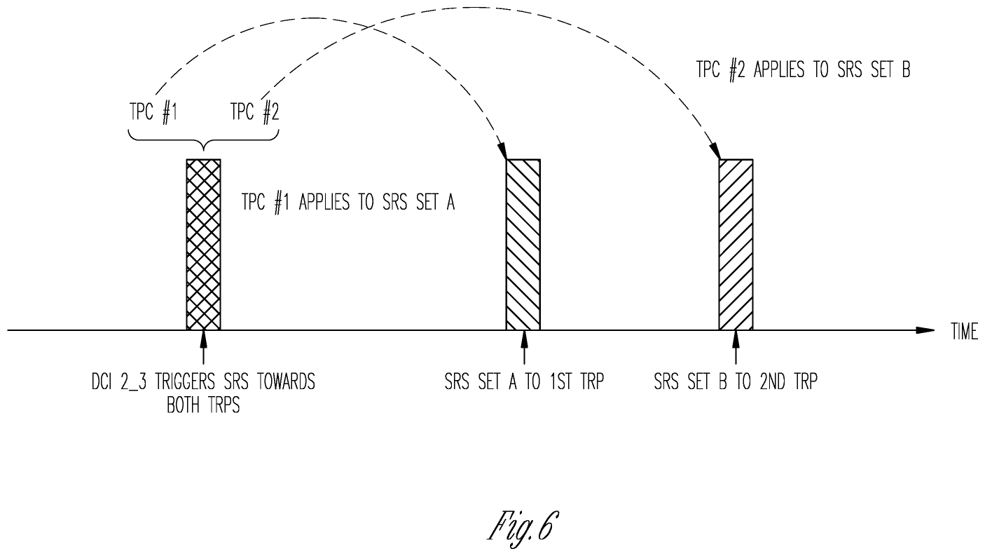

The application of TPC command to the SRS power control state may be implicitly or explicitly indicated. With implicit indication, for example, the first TPC command applies to the SRS transmission to the 1^{st} TRP, i.e., the SRS with the 1^{st} power control state. The second TPC command applies to the SRS transmission to the 2^{nd} TRP, i.e., the SRS with the 2^{nd} power control state. A triggered SRS selects the corresponding TPC command according to the power control state configuration. FIG. 6 illustrates another TRP transmission in accordance with some aspects. In particular, FIG. 6 shows an example application of TPC over DCI 2_3 to SRS.

With explicit indication, one or more additional bit(s) may be added to indicate whether the TPC command is applied to the 1^{st} SRS power control state or the 2^{nd} SRS power control state.

Dynamic switching between multi-TRP and single TRP operation is also supported. In an example, the two TPC commands are always included in the DCI 2_3. Whether a single TPC command or both TPC commands will be applied is further determined by the power control state configuration of the triggered SRS. In another example, in the DCI 2_3 without scheduling a PUSCH, whether a single TPC command is included or two TPC commands are included is configurable.

This embodiment may be applicable to both single DCI multi-TRP operation and multi-DCI multi-TRP operation. Alternatively, this embodiment may be only applicable for single DCI multi-TRP operation; for multi-DCI multi-TRP operation, only one TPC command is included in the DCI.

In another embodiment, for an SRS triggered by DCI format 2_3, One, several, or all of the following SRS power control parameters may be reconfigured via the unused bits in DCI format 2_3 to reconfigure the SRS:

SRS power control adjustment state—one of the applicable SRS power control adjustment states may be dynamically indicated over the DCI. For example, the RRC-configured power control state for the SRS is the same as the 1^{st} PUSCH power control state. In the DCI, the state may be reconfigured as a different state, for example, the separate power control state as the PUSCH or the 1^{st} separate power control state (if there are two separate power control states).

Pathloss reference signal—a list of pathloss reference signal may be configured by RRC. In the DCI, the applicable pathloss reference signal may be indicated for the SRS.

Spatial relation—a list of spatial relations may be configured by RRC. In the DCI, the applicable spatial relation may be indicated for the SRS.

P0 and alpha value—a list of P0 and a list of alpha, or a list of PO and alpha may be configured by RRC. In the DCI, the applicable P0 and alpha may be indicated for the SRS.

This embodiment may be applied for both single TRP operation and multi-TRP operation. In addition, having two separate power control states from the PUSCH may be applied to some or all the SRS usages, i.e., antenna switching, beam management, codebook/non-codebook. Having two separate power control states from the PUSCH may be applied to some or all the DCI formats that can trigger SRS, such as DCI 0_1/0_2/1_1/1_2/2_3.

### Scenario C: SRS Triggered by DCI Format 0_1/0_2 with Scheduling a PUSCH

In an embodiment, in multi-TRP operation, for an SRS triggered by DCI format 0_1/0_2 with scheduling a PUSCH, if the DCI schedules single TRP PUSCH transmission but the same DCI triggers SRS transmission toward multiple TRPs, a mismatch may exist on the application of the TPC command. Another case is that the DCI schedules a single TRP transmission toward TRP #A, while the same DCI triggers SRS transmission toward TRP #B.

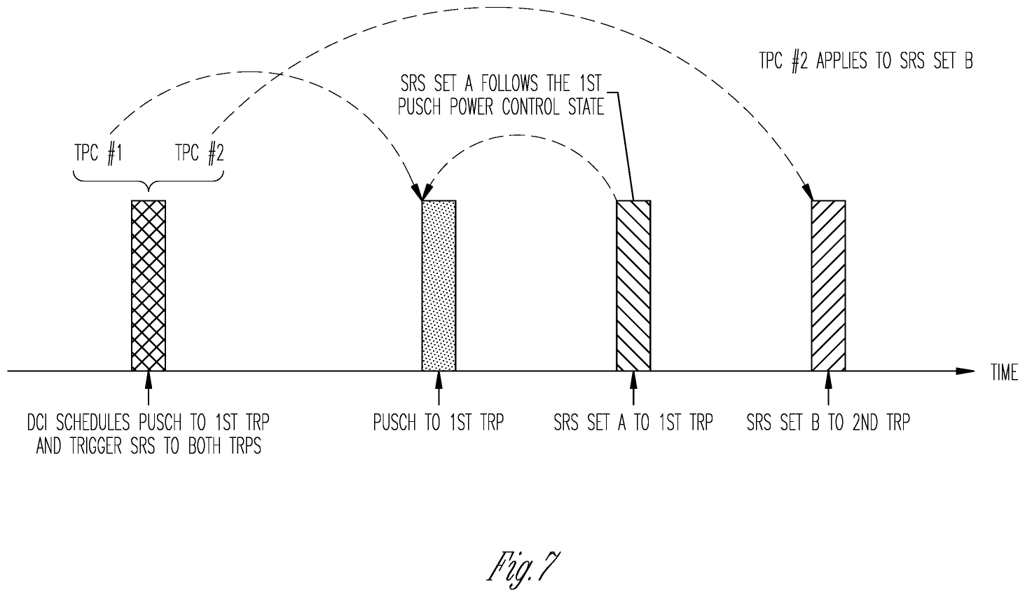

In one example, if there are always two TPC commands (TPC command #0 and #1) included in the DCI for multi-TRP operation, TPC command #0 may be used for the PUSCH/SRS transmission toward TRP #A (f_{b,f,c}(i, 0), h_{b,f,c}(i, 0)) and TPC command #1 may be used for the PUSCH/SRS transmission toward TRP #B (f_{b,f,c}(i, 1), h_{b,f,c}(i, 1)). If the DCI only schedules a single TRP PUSCH transmission toward TRP #A, and the same DCI triggers an SRS towards a different TRP, i.e., TRP #B, then the TPC command #0 is applied for the PUSCH power control state toward TRP#A (also applied to the SRS toward TRP#A if triggered). TPC command #1 is omitted by the PUSCH but is applied for the SRS power control state toward TRP #B, i.e., h_{b,f,c}(i, 1). FIG. 7 illustrates TRP command transmission in accordance with some aspects. In particular, FIG. 7 shows an example application of a TPC command to the PUSCH and SRS. Alternatively, for SRS transmission toward TRP #B, only open loop power control is applied, i.e., h_{b,f,c}(i, 1)=0.

In another example, when the DCI only schedules a single TRP PUSCH transmission, if only one TPC command is included in the DCI, then if the same DCI triggers an SRS towards a different TRP, only open look power control is applied to the SRS transmission toward the different TRP as a PUSCH. Alternatively, the TPC command may be applied to the SRS transmission no matter whether the transmission is toward the same TRP or a different TRP.

In another embodiment, for DCI format 0_1/0_2 with scheduling a PUSCH, the TPC command carried in the DCI may be interpreted as a TPC command for all the uplink channel/signals, including PUSCH, PUCCH and SRS (or at least for PUSCH and SRS). If two TPC commands are included in the DCI, then the 1^{st} TPC command applies to all the uplink channel/signals (PUSCH/PUCCH/SRS, or at least PUSCH/SRS) to the 1^{st} TRP, and the 2^{nd} TPC command applies to all the uplink channel/signals (PUSCH/PUCCH/SRS, or at least PUSCH/SRS) to the 2^{nd} TRP. This embodiment may also be applied to other DCI formats scheduling a PUSCH and carrying a TPC command, such as DCI format 0_0 and DCI format 2_2. In one example, for the SRS transmission toward one TRP, the latest TPC command applying to the corresponding TRP should be used for SRS power control, which may be carried by DCI format 0_0/0_1/0_2/2_2 and is received prior to the transmission of the SRS.

### Scenario D: PUSCH Power Control in Multi-TRP

In an embodiment, for codebook/non-codebook based transmission in multi-TRP operation, the number of SRS resource sets is increased to two. In the DCI 0_1/0_2 scheduling a PUSCH, there are two SRI fields included, with each SRI field indicating an SRS resource from a different SRS resource set. In this case, the PUSCH power control state may be explicitly or implicitly associated with different SRS resource set, or explicitly/implicitly indicated by the 1^{st} or 2^{nd} SRI field.

In an example, the order of the SRIs can implicitly indicate the PUSCH power control state: the 1^{st} SRI applies to the 1^{st} PUSCH power control state, and the 2^{nd} SRI applies to the 2^{nd} PUSCH power control state. The 1^{st} SRI indicates one SRS resource from the SRS resource set with the SRS power control state set to be the same as 1^{st} PUSCH power control state. And the 2^{nd} SRI indicates one SRS resource from the SRS resource set with the SRS power control state set to be the same as 2^{nd} PUSCH power control state.

Alternatively, the 1^{st} SRI indicates one SRS resource from the SRS resource set with lower ID, and the 2^{nd} SRI indicates one SRS resource from the SRS resource set with higher ID. The PUSCH power control state may be further indicated by the SRS power control state of the corresponding SRS resource set. For example, for the 1^{st} SRI, if the associated SRS resource set is configured with the same as the 2^{nd} PUSCH power control state, then the 1^{st} SRI applies to the 2^{nd} PUSCH power control state.

In another example, the SRS resource set may be explicitly configured with a new parameter indicating whether the 1^{st} SRI or the 2^{nd} SRI in the DCI is used for the SRS resource set. The SRS power control state configured for the SRS resource set may further indicate the PUSCH power control state for the SRI. For example, SRS resource set #B is explicitly configured to use the 1^{st} SRI and SRS resource set #B is configured with the same as the 2^{nd} PUSCH power control state. Then the 1^{st} SRI applies to the 2^{nd} PUSCH power control state.

In an embodiment, the mapping between SRI and pathloss RS/Alpha/P0 for PUSCH power control should support a configuration with multiple SRS resource sets in multi-TRP operation, i.e., TRP-specific PUSCH power control parameters should be defined.

In an example, the parameter sri-PUSCH-PathlossReferenceRS-Id and sri-P0-PUSCH-AlphaSetId in RRC may indicate two values. The first value applies to the 1^{st} PUSCH power control state, and the second value applies to the 2^{nd} PUSCH power control state. Alternatively, one additional sri-PUSCH-PathlossReferenceRS-Id and one additional sri-P0-PUSCH-AlphaSetId are included in SRI-PUSCH-PowerControl which applies to the 2^{nd} PUSCH power control state. An example of the modification on RRC Information Element (IE)

| | |
|---|---|
| SRI-PUSCH-PowerControl is shown as below. | |
| SRI-PUSCH-PowerControl ::= SEQUENCE | |
| sri-PUSCH-PowerControlId | SRI-PUSCH-PowerControlId, |
| sri-PUSCH-PathlossReferenceRS-Id | {PUSCH-PathlossReferenceRS-Id-1, |
| PUSCH-PathlossReferenceRS-Id-2} | |
| sri-P0-PUSCH-AlphaSetId | {P0-PUSCH-AlphaSetId-1, P0-PUSCH- |
| AlphaSetId-2} | |
| [symbol] | [symbol] |
| } | |

SRI-PUSCH-PowerControlId ::= INTEGER (0..maxNrofSRI-PUSCH-

Mappings-1)

maxNrofSRI-PUSCH-Mappings INTEGER ::= 16

In another example, two groups of SRI-PUSCH-PowerControl may be introduced for multi-TRP operation, one for each TRP. The 1^{st} group of SRI-PUSCH-PowerControl applies to the 1^{st} TRP (the 1^{st} PUSHC power control state), and the 2^{nd} group of SRI-PUSCH-PowerControl applies to the 2^{nd} TRP (the 2^{nd} PUSCH power control state). An example of the modification is shown as below.

sri-PUSCH-MappingToAddModList-r17 SEQUENCE (SIZE (1..maxNrofSRI-
PUSCH-Mappings)) OF SRI-PUSCH-PowerControl-r17
SRI-PUSCH-PowerControl-r17 ::= SEQUENCE

| | |
|---|---|
| sri-PUSCH-PowerControlId | SRI-PUSCH-PowerControlId, |
| sri-PUSCH-PathlossReferenceRS-Id | PUSCH-PathlossReferenceRS-Id, |
| sri-P0-PUSCH-AlphaSetId | P0-PUSCH-AlphaSetId, |
| sri-PUSCH-ClosedLoopIndex | ENUMERATED { i0 } |

}
sri-PUSCH-MappingToAddModList2 SEQUENCE (SIZE (1..maxNrofSRI-
PUSCH-Mappings)) OF SRI-PUSCH-PowerControl2-r17
SRI-PUSCH-PowerControl2-r17 ::= SEQUENCE

| | |
|---|---|
| sri-PUSCH-PowerControlId | SRI-PUSCH-PowerControlId, |
| sri-PUSCH-PathlossReferenceRS-Id | PUSCH-PathlossReferenceRS-Id, |
| sri-P0-PUSCH-AlphaSetId | P0-PUSCH-AlphaSetId, |
| sri-PUSCH-ClosedLoopIndex | ENUMERATED { i1 } |

SRI-PUSCH-PowerControlId ::= INTEGER (0..maxNrofSRI-PUSCH-
Mappings-1)
maxNrofSRI-PUSCH-Mappings INTEGER ::= 16

When performing PUSCH power control, the UE firstly determines the PUSCH power control state according to the SRI field (the corresponding PUSCH power control state according to whether it is the 1^{st} SRI field or the 2^{nd} SRI field). Then for one PUSCH power control state, the corresponding pathloss RS, P0, and alpha is determined according to the SRI codepoint and the PUSCH power control state.

### Scenario E: SRS Power Control Parameters Update

In an embodiment, for SRS in multi-TRP operation, a medium access control-control element (MAC-CE) may be introduced to update one or several of or all the following parameters: SRS power control adjustment state, or the SRS closed loop power control index; Pathloss reference signal; Spatial relation; P0 value; alpha value.

The MAC-CE may be used to update the SRS parameters above for one, several, or all the following types of SRS: Aperiodic, Semi-persistent, Periodic.

The MAC-CE may be used to update the SRS parameters above for one, several, or all the following usages of SRS: codebook, non-codebook, antennaSwitching, beamManagement

The MAC-CE may be used to update the SRS parameters above for one or multiple SRS resource sets. Or the MAC-CE may be used to update the SRS parameters above for one or multiple SRS resources within one SRS resource set. In one example, one of or several of or all the following parameters may be defined as a parameter set by RRC (alternatively, the SRS power control adjustment state, PO, and alpha may be added into the pathloss reference signal

IE or the spatial relation IE): SRS power control adjustment state, or the SRS closed loop power control index, Pathloss reference signal, Spatial relation, PO value, alpha value.

The RRC may configure a list of the parameter set to the UE, i.e., multiple parameter sets. The MAC-CE may indicate one parameter set (by the parameter set ID) to be applied for the SRS. Alternatively, the parameter set may be implicitly indicated by the Pathloss Reference Signal ID or the Spatial Relation ID.

In another example, RRC may define parameter set consisting of the following parameters: SRS power control adjustment state, or the SRS closed loop power control index, P0 value, alpha value.

The RRC may configure a list of the parameter sets to the UE, i.e., multiple parameter sets. The MAC-CE may indicate one parameter set (by the parameter set ID) to be applied for the SRS and also the indicate the pathloss reference signal ID/the spatial relation ID to be applied for the SRS.

In another embodiment, if the UE supports a Rel-17 joint DL/UL Transmission Configuration Indicator (TCI) state or Rel-17 separate DL/UL TCI state, the TCI state may be associated with one, several, or all the following parameters for SRS: SRS power control adjustment state, or the SRS closed loop power control index, Pathloss reference signal, P0 value, alpha value.

When the gNB indicates the TCI state for the UE, the related parameters may be applied for the SRS transmission.

In another example, for an SRS with antenna switching, the SRS parameters listed above should follow the indicated joint DL/UL TCI state or the separate DL TCI state. Alternatively, for an SRS with antenna switching, the beam for SRS transmission should follow the separate DL TCI state, and the SRS parameters listed above may follow the separate UL TCI state. Or the SRS parameters listed above should follow the MAC-CE.

In another example, for an SRS with beam management, if the SRS is to refine the gNB Rx beam, then the SRS parameters listed above should follow the indicated joint DL/UL TCI state or the separate UL TCI state. If the SRS is to refine the UE Tx beam, then the TCI state is not applied for the SRS and the SRS parameters listed above may follow the MAC-CE. Alternatively, for SRS with beam management, the SRS parameters listed above should follow the MAC-CE.

In another example, for an SRS with non-codebook, if the associated CSI-RS is configured, then the SRS parameters listed above should follow the MAC-CE. If the associated CSI-RS is not configured, then the SRS parameters listed above should follow the indicated joint DL/UL TCI state or the separate UL TCI state.

### Scenario F: Power Control with PDCCH Repetition

In an embodiment, when PDCCH repetition is enabled including intra-slot repetition and inter-slot repetition, if the TPC command (for PUSCH or PUCCH or SRS) is included in the DCI, the TPC command carried by multiple PDCCH repetitions is considered only once for the corresponding close loop power control state when performing uplink power control for the PUSCH/PUCCH/SRS, including both the TPC accumulation is enabled and the TPC accumulation is disabled.

### Scenario G: Power Control for Antenna Switching

In an embodiment, for an SRS with antenna switching, the Tx power is kept the same among SRS resources across one or multiple aperiodic SRS resource sets triggered by the same DCI. This may be used when closed loop power control is applied and/or when open loop power control is applied.

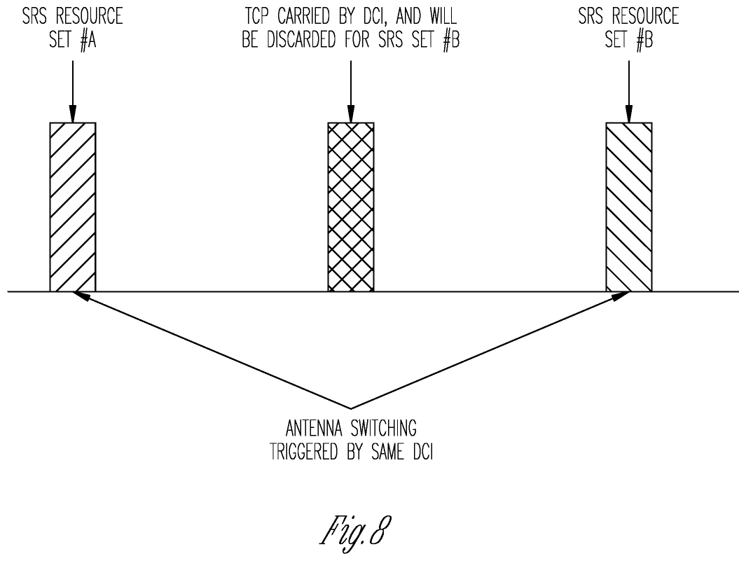

FIG. 8 illustrates power control for SRS antenna switching in accordance with some aspects. For example, with closed loop power control, if the TPC command is received between the aperiodic SRS resource sets for antenna switching triggered by the same DCI, then the TPC command is ignored, as shown by the example in FIG. 8. Alternatively, the gNB does not transmit the TPC command between the aperiodic SRS resource sets for antenna switching triggered by the same DCI.

An example of the specification change in section 7.3.1 of TS 38.213 is: if srs-PowerControlAdjustmentStates indicates the same power control adjustment state for SRS transmissions and PUSCH transmissions, the update of the power control adjustment state for SRS transmission occasion i occurs at the beginning of each SRS resource in the SRS resource set qₛ; otherwise, the update of the power control adjustment state SRS transmission occasion i occurs at the beginning of the first transmitted SRS resource in the SRS resource set qₛ. For an SRS with antenna switching, if multiple SRS resource sets are triggered by the same DCI, the update of power control adjustment occurs only at the beginning of the first transmitted SRS resource of the first SRS resource set.

In another example, for an SRS with antenna switching, if multiple SRS resource sets are triggered by the same DCI, the SRS resource sets are treated as single SRS transmission occasion.

In another embodiment, for an SRS with antenna switching, the same Tx power is maintained among all the SRS resources in the periodic/semi-persistent SRS resource set during the period (cycle) to sound all the receive antennas by transmitting all the SRS resources. Which SRS resource transmission is used as the starting point of the cycle may be pre-defined or configured/indicated by the gNB. For example, if the periodic/semi-persistent SRS resource set contains 4 SRS resources, then the same Tx power is applied for the SRS during the cycle to transmit the 4 SRS resources.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An apparatus for a 5^{th} generation NodeB (gNB), the apparatus comprising:
processing circuitry to configure the gNB to:
transmit, to a multi-transmission/reception point (TRP) operation-enabled user equipment (UE), a physical downlink control channel (PDCCH) comprising downlink control information (DCI), the DCI comprising a transmit power control (TPC) command, the TPC command for a sounding reference signal (SRS), the TPC command configured to indicate power control adjustment states for each TRP in multi-TRP operation of the UE; and
receive, from the UE, the SRS having power dependent on the TPC command; and
a memory configured to store the TPC command.

2. The apparatus of claim 1, wherein the processing circuitry is to configure the gNB to use, as the DCI, DCI format 0_1 or 0_2 without scheduling a physical uplink shared channel (PUSCH) for single TRP operation of the UE.

3. The apparatus of claim 1, wherein, for multi-TRP operation of the UE, the DCI contains multiple TPC commands applied for SRS power control, and the SRS is configured with multiple SRS power control adjustment states that are separate from physical uplink shared channel (PUSCH) power control adjustment states.

4. The apparatus of claim 3, wherein:
the DCI is DCI format 0_1 or 0_2 without scheduling a physical uplink shared channel (PUSCH) or DCI format 2_3, and
each SRS power control state is indicated as one of:
a first selection from one of: a same as a first PUSCH power control adjustment state, a same as a second PUSCH power control adjustment state, a first SRS power control state that is separate from the first and second PUSCH power control adjustment states, and a second SRS power control state that is separate from the first and second PUSCH power control adjustment states, or
a second selection from one of: the same as the first PUSCH power control adjustment state indicated by SRS power control adjustment h_{b,f,c}(i,l) with l=0, the same as the second PUSCH power control adjustment state indicated by the SRS power control adjustment h_{b,f,c}(i,l) with l=1, and an SRS power control state that is separate from the first and second PUSCH power control adjustment states.

5. The apparatus of claim 1, wherein:
the DCI is DCI format 0_1 or 0_2 without scheduling a physical uplink shared channel (PUSCH) or DCI format 2_3,
the DCI contains two TPC commands that are provided in one of:
different TPC command fields, or
a single TPC command field in which a codepoint of the single TPC command field indicates the TPC commands, and
each TPC command applies to an SRS transmission toward a different TRP.

6. The apparatus of claim 5, wherein one of:
a relationship between the TPC commands and the SRS power control states is implicitly indicated in which a first TPC command applies to a first SRS transmission to a first TRP and a second TPC command applies to a second SRS transmission to a second TRP, or
the relationship between the TPC commands and the SRS power control states is explicitly indicated by an additional bit that indicates whether each TPC command is applied to a first SRS power control state or a second SRS power control state.

7. The apparatus of claim 5, wherein at least one of:
dynamic switching between multi-TRP and single TRP operation is indicated by a power control state configuration of the SRS, or
at least one of a plurality of SRS power control parameters is reconfigured via Rel. 17 unused bits in the DCI, the at least one of SRS power control parameters selected from a set of parameters that include SRS power control adjustment state, pathloss reference signal, spatial relation, P0 value, and alpha value.

8. The apparatus of claim 1, wherein:
the DCI is DCI format 0_1 or 0_2 without scheduling a physical uplink shared channel (PUSCH), and
only open loop power control is applied for the SRS independent of which of multi-TRP operation and single TRP operation the UE is in.

9. The apparatus of claim 1, wherein:
the DCI is DCI format 0_1 or 0_2 with scheduling a physical uplink shared channel (PUSCH),
if the DCI comprises a first and second TPC command for multi-TRP operation, the first TPC command is associated with PUSCH or SRS transmission toward a first TRP and the second TPC command is associated with PUSCH or SRS transmission toward a second TRP, and
if the DCI only schedules a single TRP PUSCH transmission toward the first TRP and triggers an SRS transmission towards the second TRP, the first TPC command is associated with a PUSCH power control state toward the first TRP, and the second TPC command is associated with an SRS power control state toward the second TRP.

10. The apparatus of claim 1, wherein:
the DCI schedules only single TRP physical uplink shared channel (PUSCH) transmission,
only one TPC command is included in the DCI,
the DCI triggers an SRS transmission towards a different TRP than the PUSCH, and
only open look power control is applied to the SRS transmission.

11. The apparatus of claim 1, wherein:
the DCI is one of: DCI format 0_1 or 0_2 with scheduling a physical uplink shared channel (PUSCH), DCI format 0_0, or DCI format 2_2,
the DCI comprises a first TPC command and a second TPC command,
the first TPC command applies to a physical uplink shared channel (PUSCH) and SRS to a first TRP,
the second TPC command applies to a PUSCH and SRS to a second TRP, and
a most recent first and second TPC command is used for a current SRS towards at least the first and second TRP, respectively, the most recent first and second TPC command encoded for transmission to the UE prior to transmission of the current SRS.

12. The apparatus of claim 1, wherein:
multiple SRS resource sets are used for codebook and non-codebook-based transmission in multi-TRP operation,
the DCI is DCI format 0_1 or 0_2 with scheduling a physical uplink shared channel (PUSCH),
the DCI contains a first and second SRS resource index (SRI) field that each indicate an SRS resource from a different SRS resource set,
a PUSCH power control state is explicitly or implicitly at least one of:
associated with different SRS resource set, or
indicated by the first and second SRI field, and
implicit indication of the PUSCH power control state is based on an SRI order in which a first SRI applies to a first PUSCH power control state and a second SRI applies to a second PUSCH power control state.

13. The apparatus of claim 12, wherein one of:
the first SRI indicates one SRS resource from an SRS resource set with a SRS power control state that is a first PUSCH power control state and the second SRI indicates one SRS resource from an SRS resource set with an SRS power control state that is a second PUSCH power control state,
the first SRI indicates one SRS resource from an SRS resource set with a lower identifier (ID) and the second SRI indicates one SRS resource from an SRS resource set with a higher ID, or
the PUSCH power control state is indicated by an SRS power control state of a corresponding SRS resource set.

14. The apparatus of claim 12, wherein at least one of:
explicit configuration of a particular SRS resource set is based on whether the first and second SRI is used for the particular SRS resource set, and an SRS power control state configured for the particular SRS resource set indicates a PUSCH power control state for a corresponding SRI, or
a mapping between each SRI and characteristics that include pathloss reference signal, spatial relation, P0 and alpha value for PUSCH power control supports multiple SRS resource sets in multi-TRP operation, and the mapping is indicated by one of:
parameters sri-PUSCH-PathlossReferenceRS-Id and sri-P0-PUSCH-AlphaSetId in an SRI-PUSCH-PowerControl parameter of radio resource control (RRC) signaling each indicates one of two values: a first value that applies to a first PUSCH power control state and a second value that applies to a second PUSCH power control state,
an additional sri-PUSCH-PathlossReferenceRS-Id and additional sri-P0-PUSCH-AlphaSetId in the SRI-PUSCH-PowerControl each applies to the second PUSCH power control state, or
for multi-TRP operation, a first SRI-PUSCH-PowerControl applies to a first TRP and a second SRI-PUSCH-PowerControl applies to a second TRP.

15. The apparatus of claim 1, wherein radio resource control (RRC) signaling defines a parameter set that includes: SRS power control adjustment state, SRS closed loop power control index, P0 value, and alpha value.

16. The apparatus of claim 1, wherein, if the UE supports a Rel-17 joint downlink/uplink (DL/UL) Transmission Configuration Indicator (TCI) state or Rel-17 separate DL/UL TCI state, the TCI state is associated with at least one of SRS parameters that include:
SRS power control adjustment state, SRS closed loop power control index, pathloss reference signal, P0 value, or alpha value.

17. An apparatus for a multi-transmission/reception point (TRP) operation-enabled user equipment (UE), the apparatus comprising:
processing circuitry to configure the UE to:
receive, from a 5^{th} generation NodeB (gNB), a physical downlink control channel (PDCCH) comprising downlink control information (DCI), the DCI comprising a transmit power control (TPC) command, the TPC command for a sounding reference signal (SRS), the TPC command configured to indicate power control adjustment states for each TRP in multi-TRP operation of the UE; and
transmit, to the gNB, the SRS using power indicated by the TPC command; and
a memory configured to store the DCI.

18. The apparatus of claim 17, wherein:
the DCI is DCI format 0_1 or 0_2 with scheduling a physical uplink shared channel (PUSCH),
the DCI contains a first and second SRS resource index (SRI) field that each indicate an SRS resource from a different SRS resource set, a PUSCH power control state is explicitly or implicitly at least one of:
associated with different SRS resource set, or
indicated by the first and second SRI field, and
a mapping between each SRI and characteristics that include pathloss reference signal, spatial relation, P0 and alpha value for PUSCH power control supports multiple SRS resource sets in multi-TRP operation.

19. A non-transitory computer-readable storage medium that stores instructions for execution by one or more processors of a 5^{th} generation NodeB (gNB), the one or more processors to configure the gNB to, when the instructions are executed:
transmit, to a multi-transmission/reception point (TRP) operation-enabled user equipment (UE), a physical downlink control channel (PDCCH) comprising downlink control information (DCI), the DCI comprising a transmit power control (TPC) command, the TPC command for a sounding reference signal (SRS), the TPC command configured to indicate power control adjustment states for each TRP in multi-TRP operation of the UE; and
receive, from the UE, the SRS having power dependent on the TPC command.

20. The non-transitory computer-readable storage medium of claim 19, wherein:
the DCI is DCI format 0_1 or 0_2 with scheduling a physical uplink shared channel (PUSCH),
the DCI contains a first and second SRS resource index (SRI) field that each indicate an SRS resource from a different SRS resource set,
a PUSCH power control state is explicitly or implicitly at least one of:
associated with different SRS resource set, or
indicated by the first and second SRI field, and
a mapping between each SRI and characteristics that include pathloss reference signal, spatial relation, P0 and alpha value for PUSCH power control supports multiple SRS resource sets in multi-TRP operation.
